(19) United States
(12) Patent Application Publication
(10) Pub. No.: US 2006/0105751 A1
(43) Pub. Date: May 18, 2006

(54) Techniques for communicating personalized information

(75) Inventor: Paul Bloom, Edison, NJ (US)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 10/991,195

(22) Filed: Nov. 17, 2004

(51) Int. Cl. H04B 1/00

(52) U.S. Cl. 455/412.2; 340/5.81

(57) ABSTRACT

The present invention provides improved techniques for communicating information. In one aspect, a method of communicating personalized information is provided which comprises the following steps. A presence of an individual at a particular location is passively detected, e.g., using one or more devices at the location which are configured to be automatically responsive to one or more indicators on the individual, e.g., that uniquely identify the individual or a group to which the individual belongs. The information regarding the presence of the individual at the location is used to access at least one personalized profile for the individual. Information is collected from one or more information sources based, at least in part, on the at least one personalized profile. The collected information is then provided to the individual.

### FIELD OF THE INVENTION

The present invention relates to information transfer and, more particularly, to improved techniques for communicating information.

### BACKGROUND OF THE INVENTION

The communication of information is an important aspect in many industries. For example, in a consumer environment, retailers constantly provide information to potential customers regarding their goods. Currently, retailers are limited to mass dissemination advertising, wherein advertisements are created which are generic to a projected target audience. Some efforts may be made to tailor advertising. For example, a retailer that advertises during a sporting event may choose to promote products that sports enthusiasts would be interested in. However, conventional advertising remains nevertheless limited, making more consumer-preference specific efforts not economically viable.

As a result, many consumers receive information about products and/or services that they are not interested in. Further, with the increasing amounts of information being provided to consumers, consumers might become overwhelmed with ‘irrelevant’ advertising and miss the products or services they are actually interested in.

As such, information providers, such as retailers, would greatly benefit from more pointed and focused advertising, such as advertising based on a particular consumer's preferences. Therefore, techniques for providing personalized information are needed and would be highly desirable.

### SUMMARY OF THE INVENTION

The present invention provides improved techniques for communicating information. In one aspect of the invention, a method of communicating personalized information is provided which comprises the following steps. A presence of an individual at a particular location is passively detected, e.g., using one or more devices at the location which are configured to be automatically responsive to one or more indicators on the individual, e.g., that uniquely identify the individual or a group to which the individual belongs. The information regarding the presence of the individual at the location is used to access at least one personalized profile for the individual. Information is collected from one or more information sources based, at least in part, on the at least one personalized profile. The collected information is then provided to the individual.

A more complete understanding of the present invention, as well as further features and advantages of the present invention, will be obtained by reference to the following detailed description and drawings.

### BRIEF DESCRIPTION OF THE DRAWINGS

FIG. 1 is a flow diagram illustrating an exemplary methodology for communicating personalized information from information sources to an individual according to an embodiment of the present invention;

FIG. 2 is a flow diagram illustrating an exemplary methodology for a phase of the present techniques wherein the presence of an individual is detected at a particular location according to an embodiment of the present invention;

FIG. 3 is a flow diagram illustrating an exemplary methodology for a phase of the present techniques wherein information is collected from information sources and provided to an individual according to an embodiment of the present invention;

FIG. 4 is a flow diagram illustrating an exemplary methodology for selecting information sources according to an embodiment of the present invention;

FIG. 5 is a diagram illustrating an exemplary system for communicating personalized information from information sources to an individual according to an embodiment of the present invention; and

FIG. 6 is a diagram illustrating an exemplary system for implementing one or more of the present techniques according to an embodiment of the present invention.

### DETAILED DESCRIPTION OF PREFERRED EMBODIMENTS

FIG. 1 is a flow diagram illustrating an exemplary methodology for communicating personalized information from information sources to an individual. In step 102 of FIG. 1, the presence of an individual at a particular location, e.g., a particular room, is detected. The presence of the individual may be detected using radio frequency identification (RFID) technology. For example, the individual may have one or more indicators, such as RFID tags, on their person (e.g., the individual may have a piece of jewelry, such as a bracelet on their wrist, that contains an RFID tag). The RFID tag should uniquely identify that individual, or alternatively, a group to which that individual belongs. The RFID tag may be detected upon the individual entering the room, by one or more RFID readers configured to be responsive to, e.g., read, RFID tags. Therefore, the RFID tags are detected automatically when the individual enters the room. Namely, the detection is passive, being dependent only on the individual entering the room.

The RFID readers can be configured to have dimensions similar to a deck of cards and be mountable, e.g., at the entrance to a room. For transportability, the RFID readers may operate on battery power. However, they may alternatively, or additionally, be configured to operate on alternating current (AC) power.

In another exemplary embodiment of the present invention, indicators other than RFID tags may be used in conjunction with, or in place of, RFID tags. By way of example only, biological indicia, including, but not limited to, fingerprint patterns, voice patterns, retinal patterns and combinations comprising at least one of the foregoing biological indicia may be used to uniquely identify the individual. Use of such indicia would however require the readers to have biometric capabilities. For example, fingerprint readers, voice readers and eye scanners may be employed.

In another exemplary embodiment, the one or more indicators comprise wireless telephone signals. In this particular embodiment, the readers are configured to be responsive to such signals. For the readers to detect wireless telephone signals, the telephone would have to be turned on, however, the individual would not have to be talking on it.

According to one particular embodiment wherein the one or more indicators comprise wireless telephone signals, each wireless telephone signal is associated with a particular individual, e.g., through conventional technology that associates a wireless telephone with an individual. According to another particular embodiment wherein the one or more indicators comprise wireless telephone signals, each wireless signal is linked to a particular individual through voice recognition, e.g., from the individual speaking through the wireless telephone. In this exemplary embodiment, the individual would have to be speaking into the wireless telephone in order to be detected by the reader.

In step 104 of FIG. 1, the reader creates a message containing information for identifying the indicators detected (the indicators being linked to the identity of the individual) and information for identifying the particular reader detecting the indicators (the reader being linked to the identity of the particular location).

In an exemplary embodiment, the message created by the reader is sent via a network to a server which collects information for the individual, as described, e.g., in steps 106 and 108, below. The network may comprise any wired network, or any wireless fidelity (Wi-Fi) network, including, but not limited to, a wireless local area network (WLAN), a wireless metropolitan area network (WMAN), a worldwide interoperability for microwave access (WiMAX) network, a network enabling short-range radio communication between electronic devices and a cellular network.

When the network comprises a wired network, the reader, for example, may send the message to a wireless modem. The wireless modem could then send the message to the server over the internet, e.g., over a broadband wired connection.

When the network comprises a WLAN, for example, the message may be sent from the reader as a hypertext transfer protocol (HTTP) message to the WLAN according to the Institute of Electrical and Electronic Engineers (IEEE) standard 802.11: wireless local area network (LAN), medium access control (MAC) and physical layer (PHY) specifications. IEEE standard 802.11 specifies an over-the-air interface between a wireless client and a base station or between two wireless clients. For example, an HTTP message is sent by the reader over the internet, e.g., to the server. This type of interface is commonly employed with devices, such as personal digital assistants (PDAs) and wireless telephones that can connect to wireless networks. These devices can send and receive information from other devices and networks.

In step 106 of FIG. 1, as mentioned above, the message sent by the reader is received via the network by a server. The server is configured to access a database of user profiles, e.g., at least one of the profiles being for the individual. The server then accesses the profiles for the individual from the database.

In step 108 of FIG. 1, the server collects information from one or more information sources based, at least in part, on preferences set out in the accessed profiles for the individual. For example, based on criteria, including but not limited to, one or more of, the time of the day and the day of the week, an accessed profile might indicate that when the individual is at a particular location, e.g., the kitchen, information should be collected from the Weather Channel® website regarding the weather in New York City. An exemplary profile for an individual is provided below.

The profile may be created by the individual herself, allowing the individual to pre-select preferences regarding the information collected. Alternatively, or in addition to, one or more preferences in the profile may be determined by a party other than the individual. For example, an employer might establish certain preferences to be placed in an employee's profile.

Further, an employer might set preferences for a group of employees. Therefore, information would be collected for any individual belonging to the group which is detected, based on the preferences set by the employer for the group.

The server then sends the information collected back to the reader via the network. According to the techniques presented herein, RFID readers may be employed which are configured to, one or more of, read RFID tags, have antenna allowing for IEEE standard 802.11 interface communications with a WLAN (e.g., to access the internet) and have the ability to receive, e.g., streaming audio and/or video and play it back to the individual at the reader. In an exemplary embodiment, the reader might be interfaced with a display, e.g., an everywhere display, to stream information visually to the individual.

Further, according to an exemplary embodiment, the reader can have recording and play back capabilities to allow the individual to be presented with the information another time. For example, the individual can request that information be repeated by pressing a button.

In another exemplary embodiment, the reader is configured to receive input from the individual. For example, the individual might be able to present a query to the reader, e.g., using a keyboard. Additionally, the reader might be configured to have voice recognition capabilities so that the individual can make verbal requests.

In step 110 of FIG. 1, the reader provides the collected information to the individual. As described above, the reader can present the information to the individual as an audio stream and/or visually, e.g., on a visual display. Further, as described above, in an exemplary embodiment, the individual might request that the information be streamed to her data-enabled cellular telephone. In this embodiment, the collected information may also then be provided to the individual through her cellular telephone.

As will be described in detail below, a record may be kept regarding how many times the information has been presented to the individual to prevent excessively repetitious presentations. For example, the server may keep a record of the number of times certain information is presented to an individual and only allow that information to be repeated two times. The number of times information is repeated may be pre-selected by the individual (e.g., the system may also have a default setting regarding the number of repetitions performed, which may be altered by the individual).

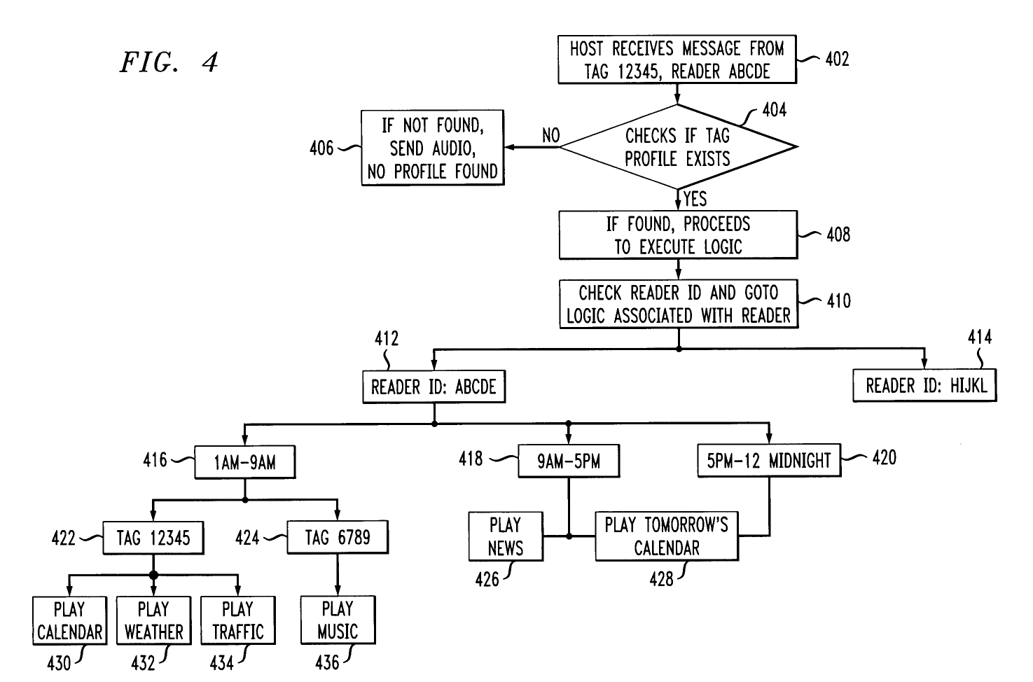

According to an exemplary embodiment of the present invention, the individual is a consumer wanting to collect information pertaining to a daily routine. The present techniques may be employed to provide information to the consumer based on one or more profiles created by the consumer. For example, the consumer may want information from information sources, such as a personalized calendar, e-mail, or from an information provider, such as the Weather Channel®, CBS News® or Mapquest® (to collect information, e.g., on weather and traffic conditions). This exemplary embodiment, wherein the individual is a consumer, is described in detail, for example, in conjunction with the description of FIG. 4, below.

According to another exemplary embodiment of the invention, the individual is an employee. The present techniques may then be used by employers to provide reminders regarding the performance of required tasks. For example, when an employee sits at her desk, her presence will be passively detected and her profile will be activated. Information may then be streamed to a reader (e.g., including calendar and activity information) in her vicinity. A derivation of this embodiment may be envisioned wherein a repairman is sent task-specific information at the next scheduled job site.

According to yet another exemplary embodiment of the invention, the individual is a student. In this embodiment, the present techniques may be employed by schools to provide information. For example, the present techniques may be employed to stream information to students regarding assignments and to announce upcoming events.

According to a further exemplary embodiment of the invention, the individual is a customer. In this embodiment, the present techniques may be employed by a retailer to provide personalized sales information. For example, a customer's purchasing preferences may be surveyed from the customer herself, or deduced from her past purchasing history.

As described above, personalized profiles for the individual need to be created. The following description of creating a personalized profile will be described in the context of an individual creating his or her own profile. However, it is to be understood that, according to the present teachings, as highlighted above, the personalized profile may be created by parties other than the individual. Further, multiple personalized profiles may be created for multiple locations.

To create the personalized profile, the user contacts the service provider, e.g., through the website of the service provider. Basically, the personalized profile will establish what information the individual desires to receive at a location during a certain, e.g., time of the day and/or day of the week.

For example, the individual may be provided with a profile template that she can populate. The profile template may be developed by the service provider or an agent of the service provider. The individual can populate the profile template through the use of an internet interface or through a natural language voice recognition interface. Accordingly, there may be different profile templates created for different situations. For example, there might be a “good morning” profile template and an “office reminder” profile template. In the “good morning” profile template, the individual would identify what information she wants presented to her, how she wants it presented (e.g., the individual might indicate that she wants information to be sent to her through a streaming audio interface as well as through her data-enabled cellular telephone) and when she wants the profile to be activated.

The following is an exemplary personalized profile an individual might establish with the service provider:
Client Name—John Smith
Name ID-RFID tag—123456789
Location ID—RFID Reader ID—ABCDEFG
User Assigned Location—bathroom
Time of day—7 AM-9 AM Monday-Friday
   Information requested—read Calendar
      Tell me weather in New York City
      Tell me traffic conditions between home and office
   Repeat information —2 times
Time of day—9 AM-5 PM Sunday-Saturday
   Information requested—news headlines
      Repeat information—5 times
Time of day—5 PM-12 midnight Sunday-Thursday
   Information requested—Read tomorrow's calendar
      Tell me tomorrow's weather forecast
Location ID RFID Reader ID-HIJKL
User assigned location kitchen
   Information requested—Play cooking channel

According to the above exemplary personalized profile, for example, if John Smith (identified by possessing RFID tag “123456789”) is at the location having RFID reader “ABCDEFG” at 10 AM on Monday, news headline information will be provided. The information will be repeated up to five times.

As part of the service, the service provider may also provide RFID tags that index the profile. Similarly, the service provider will then also provide RFID readers, which are configured to, among other things, detect and be responsive to, e.g., read, the distributed RFID tags. As described above, the RFID readers may also be configured to have an IEEE standard 802.11 interface to communicate with a WLAN and the ability to receive streaming audio and/or video and play it back to the individual at the reader.

The RFID readers may then be placed in locations where it is desired for the individual to receive information. For each location (for example, in the context of a residential setting, the bathroom, the bedroom or the kitchen), as described above, the individual will determine what information she would want transmitted to her, and at what time of the day and/or day of the week.

In an exemplary embodiment, the service provider supplies a pre-selected list of information providers (for example, Mapquest®, the Weather Channel©, Fox News©and traffic info) that the individual can then make selections from.

In a further exemplary embodiment, the profile for an individual might be dynamic. Namely, the server might have self-learning capabilities and change and/or create portions of the profile for an individual, e.g., based on how the individual reacts to certain situations. By way of example only, if the individual requests, at the reader, that certain information be repeated to her several times, despite the fact that the profile sets forth that the information not be repeated, the server might alter the profile to command repetition in later detections.

Once the personalized profile is complete and the readers are installed, service can then be initiated.

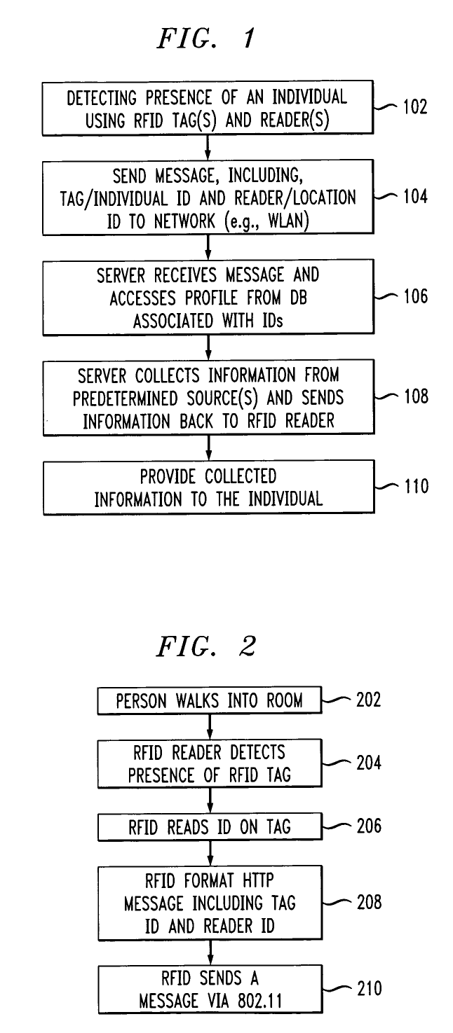

FIG. 2 is a flow diagram illustrating an exemplary methodology for a phase of the present techniques wherein the presence of an individual is detected at a particular location. Namely, FIG. 2 details what happens when a person possessing one or more of the presently described indicators comes into the proximity of one or more of the readers.

In step 202, the individual comes into the proximity of one of the readers by entering a room that contains the reader. In step 204, once the individual enters the room, the reader detects the indicators. For example, the RFID reader, described above, can detect the RFID tag the user wears on a piece of jewelry. Further, as described above, the detection of the individual is both automatic and passive, meaning that detection of the individual will occur merely by virtue of the fact that he or she has entered the room. No other action on the part of the individual is needed to initiate the detection steps.

In step 206, the RFID reader reads identification information from the RFID tag. As highlighted above, the identification information on the tag is uniquely linked to a certain individual or group of individuals. Further, as described above, should the indicators comprise biological indicia, that indicia can be uniquely linked by the system to the individual.

In step 208, the reader generates a message comprising the identification information on the tag and the identification information for the reader (e.g., the reader detecting the tag and sending the message). As highlighted above, the identification information on the tag can be used to uniquely identify the individual or group of individuals assigned that tag, and the identification information for the reader can be used to uniquely identify the location of that reader.

In step 210, the reader sends an HTTP message via IEEE standard 802.11 to a WLAN hub, which then sends the message off into the network. As described above, while the present techniques are described in terms of employing a reader having an IEEE standard 802.11 interface to communicate with a WLAN, it is to be understood that the present techniques should not be limited to that or any other particular network configuration. By way of example only, as described above, the reader might be linked to a wired network.

After the reader sends the message, it will wait n number of seconds for a response from the network. For example, the reader might wait two seconds (e.g., n=2) for a response from the network. If the reader does not get a response from the network within n seconds, the reader will re-transmit the message.

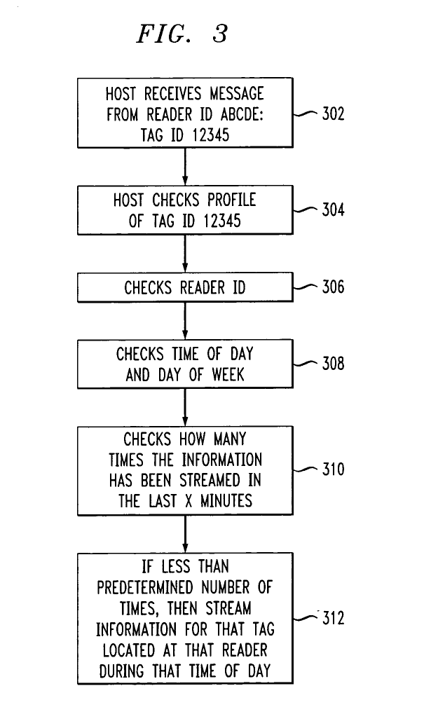

FIG. 3 is a flow diagram illustrating an exemplary methodology for a phase of the present techniques wherein information is collected from information sources and provided to an individual. Namely, FIG. 3 illustrates what happens after the message (sent by a reader through the network) reaches a server hosting that application.

In step 302, the server, e.g., host, receives the message with the RFID tag and RFID reader identification (ID) information. For example, in step 302, the message details that the reader ID is “ABCDE” and that the tag ID is “12345.”

In step 304, the server checks the profile associated with the tag detected. For example, the server will check the profile of tag ID “12345,” which uniquely identifies a particular individual or group of individuals. As highlighted above, the server is linked to a database of user profiles.

In step 306, the server checks the reader ID. As highlighted above, the reader ID can be used to uniquely identify a particular location.

In step 308, the server checks parameters, including, but not limited to, one or more of, the time of the day and the day of the week to identify what information should be transmitted to the individual. It is important to note that while it is preferable for the server to check for such parameters so as to tailor the information provided to the individual, this step is not essential. For example, an individual may be provided with information based simply on the identity of the individual and the particular location at which the individual is detected.

In step 310, the server checks how many times the information has been streamed. For example, the server checks to see how many times in the last x minutes the information has been streamed to the reader. In step 312, if the information has been streamed to the reader less than a predetermined number of times for a particular duration, then the server will re-stream the information. Checking to see how many times in the last x minutes the information has been provided to the reader is another technique to prevent excessive repetition of the information to the individual. For example, if the individual repeatedly walks into the same room within a one hour duration, the server might transmit the information to the reader only two times in that duration, even though the reader detects the individual more than twice. The individual may be given the option, e.g., when creating the profile, to specify the number of times certain information is repeated, or whether it is repeated at all.

FIG. 4 is a flow diagram illustrating an exemplary methodology for selecting information sources. In step 402 (as similarly described in conjunction with the description of step 302 of FIG. 3, above), the server receives a message from a reader, the message comprising tag identification information and reader identification information, indicating user identification and user location, respectively. In this particular example, the tag ID is “12345” and the reader ID is “ABCDE.”

In step 404 of FIG. 4, the server will verify with an associated database, whether a profile exists for that tag ID at that particular location. While, as described herein, the profile is linked to a particular individual at a particular location, the teachings herein should not be limited exclusively to these parameters. By way of example only, the server may verify a profile based on the tag ID, but not the location, e.g., therefore any reader in any location may stream information to the individual based on the tag ID (and potentially also based on the time of day and/or day of week). In this particular instance, the information streamed would not be location specific.

In step 406 of FIG. 4, if a profile associated with the tag ID and the location ID is not found, the server will send a message back to the reader that a profile was not found. The reader can then relay back to the individual that information is not available.

In step 408, if a profile is found by the server, e.g., as per step 404, the server will then proceed to execute logic. Namely, in step 410, the server will check the reader ID and goto logic associated with that reader.

In step 412, if, for example, the reader ID is “ABCDE,” then steps 416-436, as will be described in detail below, will be performed. Alternatively, if the reader has some other recognized ID, e.g., “HIJKL,” as in step 414, then a separate, yet similar, set of steps are performed (not shown or described herein).

In steps 416, 418 and 420, the server first assesses the time of day, e.g., as falling in one of interval 1 am-9 am, 9 am-5 pm or 5 pm-12 midnight, respectively. Depending on the interval assessed in steps 416, 418 and 420, for example, as in steps 422 and 424, the server might then evaluate the information to be provided based further upon the tag ID. For instance, if, as in step 422, the recognized tag ID is “12345,” then the server might relay calendar information, weather information and traffic information to the individual, e.g., as in steps 430, 432 and 434, respectively. However, as in step 424, if the recognized tag ID is “6789,” then the server might relay information related to music, e.g., for the reader to play music, as in step 436.

Alternatively, as in steps 418 and 420, if the interval assessed is either between 9 am-5 pm or 5 pm-12 midnight, the server might relay the same information regardless of the identity of the individual. For example, in steps 426 and 428 news information and calendar information, respectively, is relayed to all users having a recognized profile that are detected by the reader between 9 am-5 pm (as per step 418) and having the ID “ABCDE.”

Further, the same information may be provided to users at different intervals. For example, whether the time interval is assessed as being either between 9 am-5 pm or 5 pm-12 midnight, as in steps 418 and 420, respectively, the individual will be provided with calendar information (e.g., as in step 428).

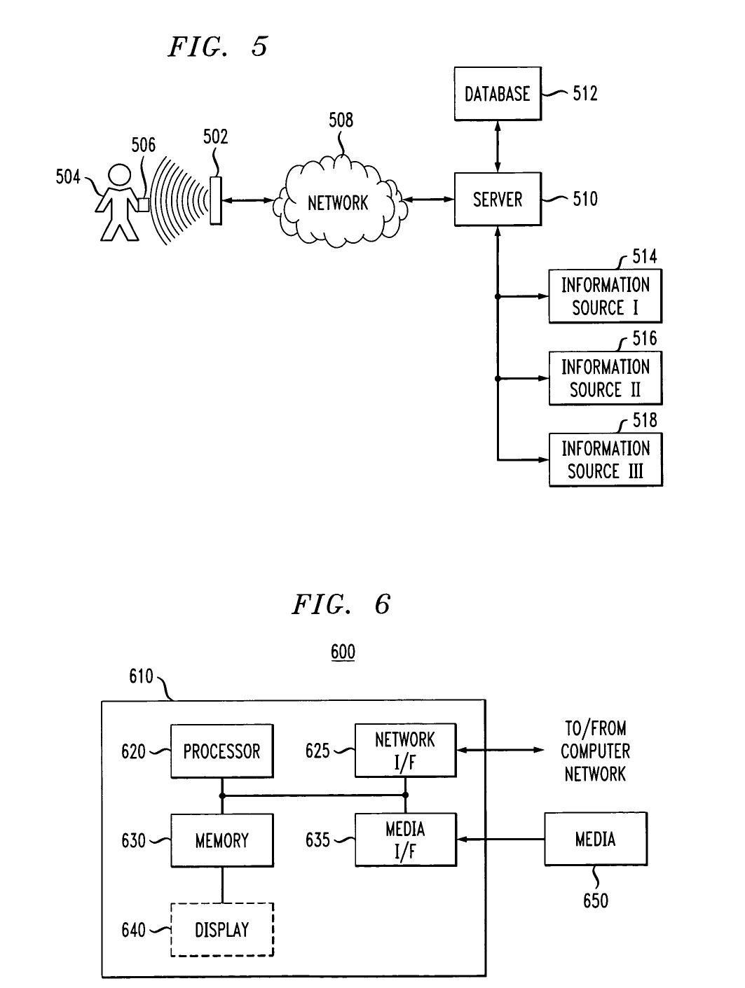

FIG. 5 is a diagram illustrating an exemplary system for communicating personalized information from information sources to an individual. In FIG. 5, reader 502 detects presence of individual 504, e.g., through detection of indicator 506 on individual 504, for example, as was described in conjunction with the description of step 102 of FIG. 1, above.

Reader 502 then creates a message containing information identifying both the reader and the indicator, e.g., signifying the identity of the location and individual 504, respectively, and sends the message through network 508 to server 510. Based on the message, server 510 accesses one or more personalized profiles for individual 504 from database of profiles 512, for example, as was described in conjunction with the descriptions of steps 104 and 106 of FIG. 1, above. Based on the personalized profile(s) accessed, server 510 will then collect information from one or more information sources, e.g., information sources 514, 516 and 518, for example, as was described in conjunction with the description of step 108 of FIG. 1, above.

Server 510 will then relay the collected information back, via network 508, to reader 502. Reader 502 can then present the information collected to individual 504, for example, through an audio and/or video interface, for example, as was described in conjunction with the description of step 110 of FIG. 1, above.

FIG. 6 is a diagram illustrating an exemplary system for implementing one or more of the present techniques. Apparatus 600 comprises a computer system 610, e.g., server 510, described, for example, in conjunction with the description of FIG. 5, above, that interacts with media 650. Computer system 610 comprises a processor 620, a network interface 625, a memory 630, a media interface 635 and an optional display 640. Network interface 625 allows computer system 610 to connect to a network, e.g., a wired network or a wireless network, as described above, while media interface 635 allows computer system 610 to interact with media 650, such as a Digital Versatile Disk (DVD) or a hard drive.

According to an exemplary embodiment, media 650 may comprise an information source, similar to information sources 514, 516 and 518, described in conjunction with the description of FIG. 5, above. By way of example only, media 650 may comprise a source of information, e.g., advertisements, that the service provider wants to present to the individual, e.g., individual 504 described in conjunction with the description of FIG. 5, above.

As is known in the art, the methods and apparatus discussed herein may be distributed as an article of manufacture that itself comprises a computer-readable medium having computer-readable code means embodied thereon. The computer-readable program code means is operable, in conjunction with a computer system such as computer system 610, to carry out all or some of the steps to perform one or more of the methods or create the apparatus discussed herein. For example, the computer-readable code is configured to implement a method for communicating personalized information to an individual, a presence of which is detected at a particular location by the steps of: using information regarding the presence of the individual at the location to access at least one personalized profile for the individual; collecting information, to be provided to the individual, from one or more information sources based, at least in part, on the at least one personalized profile.

The computer-readable medium may be a recordable medium (e.g., floppy disks, hard drive, optical disks such as a DVD, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk.

Memory 630 configures the processor 620 to implement the methods, steps, and functions disclosed herein. The memory 630 could be distributed or local and the processor 620 could be distributed or singular. The memory 630 could be implemented as an electrical, magnetic or optical memory, or any combination of these or other types of storage devices. Moreover, the term “memory” should be construed broadly enough to encompass any information able to be read from or written to an address in the addressable space accessed by processor 620. With this definition, information on a network, accessible through network interface 625, is still within memory 630 because the processor 620 can retrieve the information from the network. It should be noted that each distributed processor that makes up processor 620 generally contains its own addressable memory space. It should also be noted that some or all of computer system 610 can be incorporated into an application-specific or general-use integrated circuit.

Optional video display 640 is any type of video display suitable for interacting with a human user of apparatus 600. Generally, video display 640 is a computer monitor or other similar video display.

Although illustrative embodiments of the present invention have been described herein, it is to be understood that the invention is not limited to those precise embodiments, and that various other changes and modifications may be made by one skilled in the art without departing from the scope or spirit of the invention.

What is claimed is:

1. A method of communicating personalized information, the method comprising the steps of:
passively detecting a presence of an individual at a particular location;
using information regarding the presence of the individual at the location to access at least one personalized profile for the individual;
collecting information from one or more information sources based, at least in part, on the at least one personalized profile; and
providing the collected information to the individual.

2. The method of claim 1, wherein the detecting step further comprises the step of using one or more devices at the location which are configured to be automatically responsive to one or more indicators on the individual.

3. The method of claim 2, wherein the one or more indicators uniquely identify the individual or a group to which the individual belongs.

4. The method of claim 1, further comprising the step of creating the at least one personalized profile for the individual.

5. The method of claim 1, wherein the at least one personalized profile comprises parameters determined by the individual.

6. The method of claim 1, wherein the at least one personalized profile comprises parameters determined by a party other than the individual.

7. The method of claim 1, wherein the at least one personalized profile comprises parameters determined by an employer.

8. The method of claim 1, wherein the at least one personalized profile comprises parameters determined by a retailer.

9. The method of claim 2, wherein one or more of the devices configured to be automatically responsive to the one or more indicators on the individual comprise a radio frequency identification reader device.

10. The method of claim 2, wherein one or more of the devices configured to be automatically responsive to the one or more indicators on the individual comprise a biometric reader.

11. The method of claim 2, wherein one or more of the indicators comprise radio frequency identification tags.

12. The method of claim 2, wherein one or more of the indicators comprise biological indicia selected from the group consisting of fingerprint patterns, voice patterns, retinal patterns and combinations comprising at least one of the foregoing biological indicia.

13. The method of claim 2, wherein one or more of the indicators comprise wireless telephone signals.

14. The method of claim 1, wherein the using step further comprises the steps of:
providing information identifying the individual;
providing information identifying the location; and
using the information identifying the individual and the information identifying the location to access the at least one personalized profile for the individual.

15. The method of claim 1, wherein one or more of the information regarding the presence of the individual at the location and the information collected from the one or more information sources are transmitted over a wireless fidelity network.

16. The method of claim 1, wherein one or more of the information regarding the presence of the individual at the location and the information collected from the one or more information sources are transmitted over a wireless local area network.

17. The method of claim 1, wherein the at least one personalized profile comprises criteria selected from the group consisting of time of day, day of week and combinations comprising at least one of the foregoing criteria.

18. The method of claim 1, further comprising the step of repeating one or more of the using, collecting and providing steps in response to a repeat detection of the presence of the individual at the location.

19. The method of claim 1, further comprising the step of repeating one or more of the using, collecting and providing steps a predetermined maximum number of times in response to a repeat detection of the presence of the individual at the location.

20. The method of claim 19, wherein the predetermined maximum number of times is determined by the individual.

21. The method of claim 1, wherein the using, collecting and providing steps are performed, at least in part, by a server.

22. The method of claim 1, wherein the providing step is performed, at least in part, by one or more devices at the location which are configured to be automatically responsive to one or more indicators on the individual.

23. The method of claim 1, wherein the collected information is provided to the individual as one or more of audio data and video data.

24. An apparatus for communicating personalized information to an individual, a presence of which is passively detected at a particular location, the apparatus comprising:
a memory; and
at least one processor, coupled to the memory, operative to:
use information regarding the presence of the individual at the location to access at least one personalized profile for the individual; and
collect information, to be provided to the individual, from one or more information sources based, at least in part, on the at least one personalized profile.

25. An article of manufacture for communicating personalized information to an individual, a presence of which is passively detected at a particular location, comprising a machine readable medium containing one or more programs which when executed implement the steps of:
using information regarding the presence of the individual at the location to access at least one personalized profile for the individual; and
collecting information, to be provided to the individual, from one or more information sources based, at least in part, on the at least one personalized profile.
